(19) United States
(12) Patent Application Publication
(10) Pub. No.: US 2026/0178273 A1
(43) Pub. Date: Jun. 25, 2026

(54) METHOD AND APPARATUS FOR REDUCING COMPUTATION TIME

(71) Applicant: KOREA ADVANCED INSTITUTE OF SCIENCE AND TECHNOLOGY, Daejeon (KR)

(72) Inventors: Myoung soo JUNG, Daejeon (KR); Hui Won CHOI, Daejeon (KR); Seong Hyeon JANG, Daejeon (KR)

(73) Assignee: KOREA ADVANCED INSTITUTE OF SCIENCE AND TECHNOLOGY, Daejeon (KR)

(21) Appl. No.: 19/428,753

(22) Filed: Dec. 22, 2025

(30) Foreign Application Priority Data
Dec. 20, 2024 (KR) 10-2024-0192678
Dec. 16, 2025 (KR) 10-2025-0199889

(51) Int. Cl. G06F 5/01; G06F 7/523

(52) U.S. Cl. CPC G06F 5/01; G06F 7/523

(57) ABSTRACT

A method and apparatus for reducing computation time are disclosed herein which provides in at least one embodiment a computer-implemented method for reducing computation time, the computer-implemented method including the steps of: receiving one or more bits from a multiplier, generating a shift signal by using the one or more bits, performing a shift operation by n bits (where n is a natural number) based on the shift signal to obtain a partial product, and generating an output product by using the partial product and then outputting the output product.

### CROSS-REFERENCE TO RELATED APPLICATIONS

This application claims priority to and the benefit of Korean Patent Application No. 10-2025-0199889, filed on Dec. 16, 2025, which claims priority to and the benefit of Korean Patent Application No. 10-2024-0192678, filed on Dec. 20, 2024, the disclosures of which are incorporated by reference herein in their entirety.

### TECHNICAL FIELD

The present disclosure in some embodiments relates to a method and apparatus for reducing computation time. More particularly, the present disclosure relates to a method and apparatus for improving the computing speed of a bit-serial multiplier while maintaining its degree of precision.

### BACKGROUND

The statements in this section merely provide background information related to the present disclosure and do not necessarily constitute prior art.

A bit-parallel multiplier generates partial products in parallel, sums these partial products, and thereby performs the multiplication operation. When using a bit-parallel multiplier, the multiplication operation takes a short time, but there is the issue of increased circuit area and power consumption.

A bit-serial multiplier performs operations sequentially on each bit of a multiplier. The bit-serial multiplier generates a partial product for each bit and repeatedly performs summing and shift operations to complete the multiplication. The bit-serial multiplier can perform operations on all bits regardless of the multiplier's bit size, but it has the disadvantage of requiring a longer time per multiplication operation.

Therefore, a technique is required to improve the operation speed while maintaining the precision of the bit-serial multiplier.

### SUMMARY

According to at least one embodiment, the present disclosure provides a computer-implemented method for reducing computation time, including the steps of: receiving one or more bits from a multiplier, generating a shift signal by using the one or more bits, performing a shift operation by n bits (where n is a natural number) based on the shift signal to obtain a partial product, and generating an output product by using the partial product and then outputting the output product.

According to another embodiment, the present disclosure provides an apparatus for reducing computation time, the apparatus including a memory configured to store instructions, and at least one processor, wherein the at least one processor executing the instructions is configured to perform the steps of: receiving one or more bits from a multiplier, generating a shift signal by using the one or more bits, performing a shift operation by n bits (where n is a natural number) based on the shift signal to obtain a partial product, and generating an output product by using the partial product and then outputting the output product.

### BRIEF DESCRIPTION OF THE DRAWINGS

FIG. 1 is a schematic block diagram illustrating the configuration of an apparatus for reducing computation time according to at least one embodiment of the present disclosure.

FIG. 2 is a flowchart of the process by which a computation time reducer (10) calculates an output product according to at least one embodiment of the present disclosure.

FIG. 3 is a block diagram of a look-up table module (110) using a dual-port memory according to at least one embodiment of the present disclosure.

FIG. 4 is a flowchart of a method of reducing computation time according to at least one embodiment of the present disclosure.

FIG. 5 is a schematic diagram illustrating a configuration of a computing device that may be used to implement the apparatuses and methods described herein.

### REFERENCE NUMERALS

10: computation time reducer 20: summing and shift operation module
110: look-up table module 120: address generation module
130: shifter module 140: shift register module

### DETAILED DESCRIPTION

The present disclosure seeks to provide a method and apparatus for reducing computation time. In particular, the present disclosure seeks to provide a method and apparatus that receives bits from multipliers as inputs, uses the received bits to generate shift signals, performs a data operation by 3 bits based on the shift signals to obtain a partial product, and performs an operation on the partial product to yield the output product.

The matters addressed by the present disclosure are not limited to those mentioned above, and other unmentioned matter will be clearly understood by those skilled in the art from the following description.

Hereinafter, some embodiments of the present disclosure will be described in detail with reference to the accompanying drawings. In the following description, like reference numerals preferably designate like elements, although the elements are shown in different drawings. Further, the following description of some embodiments will omit, for the purpose of clarity and brevity, a detailed description of related known components and functions when considered to obscure the subject of the present disclosure.

Various ordinal numbers or alpha codes, such as first, second, i), ii), a), b), etc., are prefixed to describe the components of embodiments of the present disclosure. They are used solely to differentiate one component from the other but not to imply or suggest the substances, order, or sequence of the components. Throughout this specification, when a part ‘includes’ or ‘comprises’ a component, the part is meant to further include other components, to not exclude thereof unless specifically stated to the contrary.

The description of the present disclosure to be presented below in conjunction with the accompanying drawings is intended to describe exemplary embodiments of the present disclosure and is not intended to represent the only embodiments in which the technical idea of the present disclosure may be practiced.

A computing device capable of incorporating or executing a method and apparatus for reducing computation time according to at least one embodiment of the present disclosure may be a smartphone, tablet, wearable device, desktop computer, laptop, smart speaker, vehicle infotainment device, kiosk, mixed reality headset, or virtual reality headset.

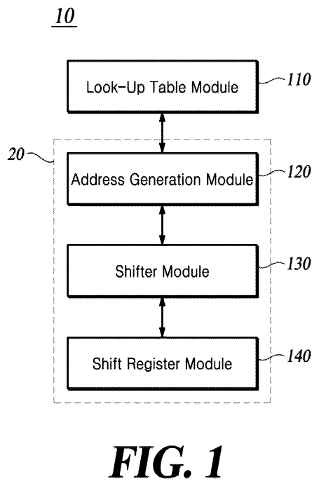

FIG. 1 is a schematic block diagram illustrating the configuration of an apparatus 10 for reducing computation time according to at least one embodiment of the present disclosure. Not all blocks shown in FIG. 1 are requisite components, and some blocks may be added, deleted, or modified in other embodiments. The components shown in FIG. 1 may be implemented as one or more software modules or components installed on one or more computing devices at one or more locations. In some implementations, one or more computing devices may be dedicated to specific components.

The following describes, with reference to FIG. 1, the apparatus 10 for reducing computation time (hereinafter referred to as a ‘computation time reducer’) according to at least one embodiment of the present disclosure.

The computation time reducer 10 uses bits of each of multipliers to generate a shift signal, uses the shift signal as a basis to obtain a partial product, and then performs an operation on the partial product to output the product obtained.

The computation time reducer 10 includes a look-up table module 110 and a summing and shift operation module 20. The summing and shift operation module 20 may include one or more of an address generation module 120, a shifter module 130, and a shift register module 140.

The look-up table module 110 may store pre-calculated values in a table format to quickly obtain data corresponding to an input. Instead of performing complex operations, the look-up table module 110 can rapidly output data from the stored table. Here, the data is composed of one or more bits and may be represented as a bit sequence.

The look-up table module 110 may access memory to obtain data, thus eliminating the need for additional arithmetic units for computation. Consequently, the computational circuitry is simplified, effectively reducing power consumption and hardware area.

When the computation time reducer 10 processes inputted bits sequentially, the multiplication operation speed may be relatively slow. However, thanks to the look-up table module 110 storing values to be utilized, the computation time reducer 10 can quickly obtain the results of partial products, significantly improving the operation speed. The look-up table module 110 obtains and transmits data to the address generation module 120.

The address generation module 120 receives data from the look-up table module 110. The data may be provided to the address generation module 120 sequentially in 3-bit chunks, starting from the least significant bit (LSB) to the most significant bit (MSB). The address generation module 120 may use the inputted bits to generate an address for the look-up table module 110 to reference and may provide the generated address to the look-up table module 110.

The address generation module 120 may generate the shift signal to specify the size of the shift operation to be performed on the value obtained from the lookup table. The shift signal may indicate the address of the lookup table, to be referenced based on the inputted-bit combination, and the shift amount by which the lookup table's address to be referenced needs shifting to generate the partial product.

TABLE 1

| Input | Address | Shift Signal |
|---|---|---|
| 000 | X | X |
| 001 | 00 | 00 |
| 010 | 00 | 10 |
| 011 | 01 | 00 |
| 100 | 00 | 10 |
| 101 | 10 | 00 |
| 110 | 01 | 01 |
| 111 | 11 | 00 |

Table 1 shows the operating rules of the address generation module 120 for generating the address to be provided to the look-up table module 110 and the shift signal to be transmitted to the shifter module 130, based on the combination of inputted bits. The address generation module 120 uses as a basis the inputted 3-bit value to generate an address corresponding to which entry the look-up table module 110 will reference. The shifter module 130 determines how many bits to shift.

The input bits are, for example, composed of 3 bits. The input bits represent a bit combination for the multiplier. An input value of 000 indicates no value to multiply, while input values from 001 to 111 represent integers from 1 to 7, respectively. The address may be used as an index specifying which value to reference from the look-up table module 110.

For example, when the address is 00, the value outputted from the look-up table may be A*1, and when the address is 01, the value outputted from the look-up table may be A*3. Here, A denotes a constant. For address 10, A*5 corresponds to the value stored in the look-up table module 110, and for address 11, A*7 corresponds thereto. Only odd multiples are stored in the look-up table because even multiples may be generated by shifting the value read from the look-up table. Here, * is used to denote multiplication operation.

Here, A denotes the multiplicand. For example, in the operation A*B where A is multiplied by B, A represents the multiplicand and B represents the multiplier.

The shift signal is a control signal indicating how much to shift the lookup table value by using the address determined by the address generation module 120 to generate the partial product. For example, if the input bits are 001, the address is 00, and the shift signal is 00, then no shift operation is applied, so the final result is 1A. If the input bits are 100, the address is 00, and the shift signal is 10, then the summing and shift operation module 20 receives A*1 from the look-up table module 110 and shifts the A*1 to the left by 2 bits, resulting in the final output 4A.

The address generation module 120 generates, based on the inputted 3-bit value, an address for the look-up table module 110 to reference and a shift signal to be provided to the shifter module 130. The look-up table module 110 stores odd multiples of constant A. Even multiples may be generated by shifting the value received from the look-up table to the left. The address generation module 120 is designed to calculate the address and shift signal based on the inputted-bit combination, thereby generating the partial products from A*1 to A*7.

The address generation module 120 may determine the address and shift signal by using combinational logic according to the inputted bits. Since the address generation module 120 does not store data internally, it may be synthesized as a combinational circuit form that does not include latches or registers. This results in the advantage of not significantly increasing hardware area or power consumption.

The shifter module 130 receives the shift signal generated by the address generation module 120 and performs the operation of shifting data. The shifter module 130 may shift data based on the shift signal and use the shift operation result to obtain the partial product.

The shifter module 130 may shift data left or right according to the shift signal. When the shifter module 130 shifts data to the left, the value doubles. For example, 0101 represents the decimal number 5; shifting 0101 left by one bit results in 1010. Expressing 1010 as an integer yields the decimal number 10, confirming it is twice 5.

Conversely, when the shifter module 130 shifts data to the right, the value is halved. For example, 0110 represents the integer 6. Shifting 0110 one bit to the right yields 0011, which represents the integer 3. Using the shifter module 130 enables fast execution of 2ⁿ or (½)ⁿ operations without requiring a multiplier device.

The shifter module 130 transmits the obtained partial product to the shift register module 140. The shift register module 140 computes the partial product to generate and then yields an output product.

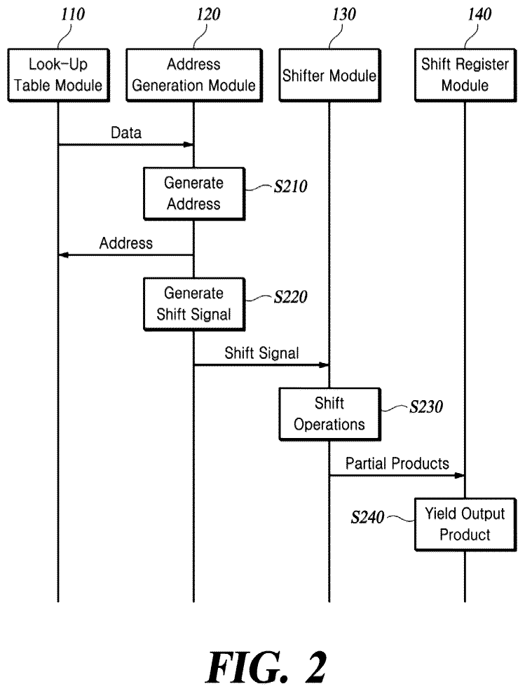

FIG. 2 is a flowchart of the process by which the computation time reducer 10 calculates the output product according to at least one embodiment of the present disclosure.

To enable the computation time reducer 10 to obtain data quickly, the look-up table module 110 may pre-calculate and store values in a table format. The look-up table module 110 may rapidly output data from the stored table. The look-up table module 110 transmits the outputted data to the address generation module 120.

The address generation module 120 uses the data received from the look-up table module 110 to generate an address (S210). The address generation module 120 may use, for example, 3 bits when generating the address. Unlike conventional methods that processed multiplier bits one at a time, the present disclosure processes multiplier bits in groups of 3, enabling operations to be performed in fewer cycles and supporting various bit operations. The address generation module 120 may transmit the generated address to the look-up table module 110.

The address generation module 120 may generate a shift signal (S220). The shift signal is used to specify the size of the shift operation to be performed by the shift module 130. The shift signal may indicate the address in the lookup table and the amount by which the lookup table is shifted. The address generation module 120 may calculate and yield the address and shift signal based on the inputted-bit combination to generate the partial product. The shift signal may be provided to the shifter module 130.

The shifter module 130 may receive the shift signal and perform shift operations (S230). The shifter module 130 shifts data based on the shift signal and use the shift operation result to obtain the required partial product. The shifter module 130 may shift data either left or right. When shifting data left, the value doubles each time it is shifted. When shifting data right, the value halves each time it is shifted.

The shifter module 130 passes the obtained partial product to the shift register module 140. The shift register module 140 may compute the partial product to generate and then yield an output product (S240).

When the computation time reducer 10 processes the bits of the multiplier in groups of three bits, it can perform more rapid multiplication operation between the multiplicand and the multiplier. Since the range of numbers expressible by 3 bits is 0 to 7, the computation time reducer 10 may simultaneously generate partial products from 0A to 7A in 3-bit units.

Conventional techniques required additional adders to generate values like 3A or 5A, which are odd multiples, thus presenting a limitation in simultaneously processing multiple bits. In contrast, the computation time reducer 10 of the present disclosure pre-stores in the look-up table module 110 the results of multiplying multiplicand A by 1, 3, 5, or 7 and applies simple shift operations when needed, thereby efficiently obtaining all partial products from 1A to 7A.

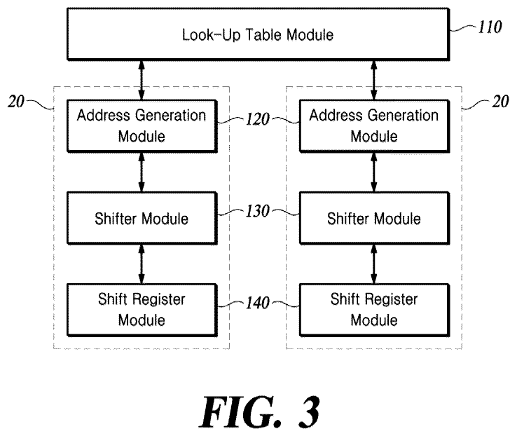

FIG. 3 is a block diagram of the look-up table module 110 using a dual-port memory according to at least one embodiment of the present disclosure.

The look-up table module 110 may store values such as A, 3A, 5A, or 7A, which are the multiplicand A multiplied by constants. When implemented using a memory capable of reading or writing, the look-up table module 110 may be configured by using memory elements such as latches or Static Random Access Memory (SRAM).

When the look-up table module 110 is constructed by using a dual-port memory, two of the summing and shift operation module 20 may simultaneously reference the same look-up table module 110. This allows for more efficient utilization of the hardware resources required by the operation modules.

The dual-port memory provides two independent ports and has a structure that allows simultaneous memory read or write operations by using both ports. Unlike a single-port memory, the dual-port memory enables parallel access by using two different ports, thereby reducing bottlenecks and improving memory access efficiency.

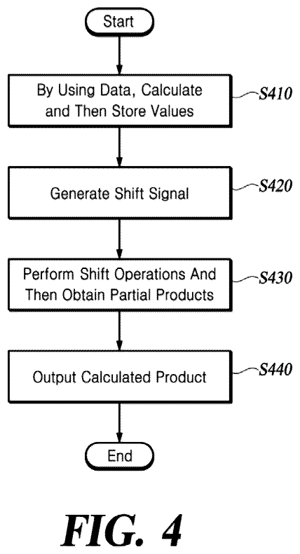

FIG. 4 is a flowchart of a method of reducing computation time according to at least one embodiment of the present disclosure.

The look-up table module 110 is to obtain data corresponding to an input by pre-calculating and storing values in a table format (S410). The look-up table module 110 outputs values from the stored table instead of directly performing complex operations, thereby reducing computation time.

Using the look-up table module 110 obviates the need for separate arithmetic units for complex operations, simplifying the computational circuitry and reducing power consumption. The look-up table module 110 may obtain data from the table and provide it to the address generation module 120.

The address generation module 120 uses the inputted data to generate an address for the look-up table module 110 to reference, then transmits the address to the look-up table module 110. The address generation module 120 may uses the received data as a basis for generating a shift signal (S420). The shift signal is a control signal indicating the address of the lookup table to be referenced and how much to shift the value read from that address. The address serves as an index specifying which item to select from the values stored in the lookup table.

The address generation module 120 does not store data internally and may determine the address and shift signal by using combinational logic based on input bits. Therefore, the address generation module 120 may be implemented as a combinational circuit form that does not include latches or registers, resulting in a hardware area reduction and power consumption savings.

The shifter module 130 uses the bit values and the shift signal to perform shift operations and then generate partial products (S430). The shifter module 130 may shift the data based on the shift signal. When the shifter module 130 shifts the data to the left, the value increases; when shifting the data to the right, the value decreases.

The operation performed by the shifter module 130 is not an operation between variables, but an operation between a constant and variables. The values obtained by multiplying the multiplicand by the constant is pre-stored in the look-up table module 110. By looking up the value based on the bit value of a multiplier, the partial product may be generated without additional summing operations. Using a look-up table enables the implementation of a faster bit-serial multiplier.

The shifter module 130 passes the generated partial product to the shift register module 140. The shift register module 140 may use the received partial product to perform operations and then yield the output product (S440).

Conventional techniques used either bit-parallel multipliers or bit-serial multipliers, leading to a trade-off: increasing precision resulted in longer computation times, while reducing computation time led to lower precision.

However, the computation time reducer 10 of the present disclosure operates by combining the look-up table module 110, the address generation module 120, the shifter module 130, and the shift register module 140. This enables the computation time reducer 10 to support various levels of precision while maintaining fast computation time. The computation time reducer 10 resolves the trade-off issue between precision and computation time.

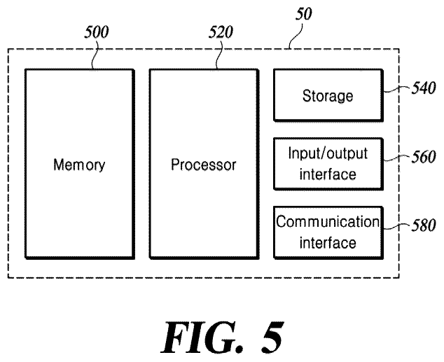

FIG. 5 is a schematic block diagram of an illustrative configuration of a computing device that may be used to implement the method and apparatus according to the present disclosure.

A computing device 50 may be provided with some or all of a memory 500, a processor 520, a storage 540, an input/output interface 560, and a communication interface 580. The computing device 50 may be a stationary computing device, such as a desktop computer, server, etc., as well as a mobile computing device, such as a laptop computer, smartphone, etc. The computing device 50 may include any specialized hardware accelerator capable of efficiently processing computations on the artificial intelligence model. For example, the computing device 50 may include a graphics processing unit (GPU), a tensor processing unit (TPU), or a neural processing unit (NPU).

The memory 500 may store programs that cause the processor 520 to perform method(s) or operation(s) of various embodiments of the present disclosure. For example, the program may include a plurality of commands executable by the processor 520, and the commands may be executed by the processor 520 to perform the method(s) or operation(s) described above. The memory 500 may be a single memory or a plurality of memories. In this case, the information required to perform the methods or operations according to various embodiments of the disclosure may be stored in a single memory or stored in a distributed manner among the plurality of memories. When the memory 500 is composed of a plurality of memories, they may be physically separated. The memory 500 may include at least one of volatile memory and non-volatile memory. The volatile memory may include static random access memory (SRAM) or dynamic random access memory (DRAM) among others, and the non-volatile memory may include flash memory among others.

The processor 520 may include at least one core capable of executing at least one set of commands. The processor 520 may execute commands stored in the memory 500. The processor 520 may be a single processor or a plurality of processors.

The storage 540 maintains stored data even when power to the computing device 50 is interrupted. For example, the storage 540 may include non-volatile memory or may include a storage medium such as magnetic tape, optical disk, or magnetic disk. Programs stored in the storage 540 may be loaded into the memory 500 before execution by the processor 520. The storage 540 may store files written in a programming language, and programs generated by a compiler or the like may be loaded from the files into the memory 500. The storage 540 may store data to be processed by the processor 520 and/or data that has been processed by the processor 520.

The input/output interface 560 may provide an interface with an input device, such as a keyboard, mouse, etc., and/or with an output device, such as a display device, printer, etc. A user may trigger the execution of a program by the processor 520 via the input device and/or view the results of processing by the processor 520 via the output device.

The communication interface 580 may provide access to an external network. The computing device 50 may communicate with other devices, e.g. user equipment or vehicles via the communication interface 580.

The respective components of the apparatus and method may be implemented as hardware or software, or hardware and software combined. Additionally, the function of each component may be implemented by software, and a microprocessor may be implemented to execute the function by software, corresponding to each component.

Various illustrative implementations of the systems and methods described herein may be realized by digital electronic circuitry, integrated circuits, field-programmable gate arrays (FPGAs), application-specific integrated circuits (ASICs), computer hardware, firmware, software, and/or their combination. These various implementations can include those realized in one or more computer programs executable on a programmable system. The programmable system includes at least one programmable processor coupled to receive and transmit data and instructions from and to a storage system, at least one input device, and at least one output device, wherein the programmable processor may be a special-purpose processor or a general-purpose processor. The computer programs (which are also known as programs, software, software applications, or code) contain instructions or commands for a programmable processor and are stored in a “computer-readable recording medium.”

The computer-readable recording medium includes any type of recording device on which data that can be read by a computer system is recordable. Examples of computer-readable recording media include non-volatile or non-transitory media such as a ROM, CD-ROM, magnetic tape, floppy disk, memory card, hard disk, optical/magnetic disk, storage devices, and the like. The computer-readable recording mediums may further include transitory media such as a data transmission medium. Further, the computer-readable recording medium can be distributed in computer systems connected via a network, wherein the computer-readable codes can be stored and executed in a distributed mode.

Although the steps in the respective flowcharts/timing charts are described in this specification as being sequentially performed, they merely instantiate the technical idea of some embodiments of the present disclosure. Therefore, a person having ordinary skill in the pertinent art to the respective embodiments could perform the steps without departing from the idea and scope of the embodiments by changing the sequences described in the respective flowcharts/timing charts or by performing two or more of the steps in parallel, and hence the steps in the respective flowcharts/timing charts are not limited to the illustrated chronological sequences.

At least one embodiment of the present disclosure can provide a multiplier device that maintains high computational precision while having a little computational delay time. The present disclosure provides a structure implementation that combines the advantages of high-speed computation offered by a bit-parallel multiplier with the footprint and power efficiency benefits provided by a bit-serial multiplier. The present disclosure can achieve the effect of improving computational speed without compromising precision.

According to at least one embodiment of the present disclosure, computational resources can be shared among multiple multiplier devices, thereby reducing hardware resource requirements and enabling efficient parallel processing. The resource sharing allows the same computational block to be repeatedly utilized across multiple computational flows, simultaneously reducing the overall system area and power consumption while maximizing computational efficiency.

The effects of the present disclosure are not limited to those mentioned above, and other effects not mentioned herein will be clearly understood by those skilled in the art from the above description.

Although exemplary embodiments of the present disclosure have been described for illustrative purposes, those skilled in the art will appreciate that various modifications, additions, and substitutions are possible without departing from the idea and scope of the claimed invention. Therefore, exemplary embodiments of the present disclosure have been described for the sake of brevity and clarity. The scope of the technical idea of the embodiments of the present disclosure is not limited by the illustrations. Accordingly, the scope of protection of the embodiments shall be interpreted according to the appended claims, and all technical concepts within the scope equivalent thereto shall be interpreted as falling within the scope of rights of the embodiments.

1. A computer-implemented method for reducing computation time, the computer-implemented method comprising the steps of:
receiving one or more bits of a multiplier;
generating a shift signal by using the one or more bits;
performing a shift operation by n bits (where n is a natural number) based on the shift signal to obtain a partial product; and
generating an output product by using the partial product and then outputting the output product.

2. The computer-implemented method of claim 1, wherein the one or more bits are inputted in groups of three bits, sequentially from a least significant bit to a most significant bit.

3. The computer-implemented method of claim 1, wherein the shift operation utilizes a lookup table, and
wherein the lookup table stores a product of multiplying a multiplicand by a constant.

4. The computer-implemented method of claim 3, wherein the lookup table is constructed by using a dual-port memory.

5. The computer-implemented method of claim 1, wherein the shift signal is generated by using an address generator, and
wherein the address generator generates an address based on the bits of the multiplier.

6. An apparatus for reducing computation time, the apparatus comprising:
a memory configured to store instructions; and
at least one processor,
wherein the at least one processor executing the instructions is configured to perform the steps of:
receiving one or more bits of a multiplier;
generating a shift signal by using the one or more bits;
performing a shift operation by n bits (where n is a natural number) based on the shift signal to obtain a partial product; and
generating an output product by using the partial product and then outputting the output product.

7. The apparatus of claim 6, wherein the one or more bits are inputted in groups of three bits, sequentially from a least significant bit to a most significant bit.

8. The apparatus of claim 6, wherein the shift operation utilizes a lookup table, and
wherein the lookup table stores a product of multiplying a multiplicand by a constant.

9. The apparatus of claim 8, wherein the lookup table is constructed by using a dual-port memory.

10. The apparatus of claim 6, wherein the shift signal is generated by using an address generator, and
wherein the address generator generates an address based on the bits of the multiplier.

11. A computer program stored on a computer-readable recording medium for executing each of the steps included in the method according to claim 1.

12. A computer program stored on a computer-readable recording medium for executing each of the steps included in the method according to claim 2.

13. A computer program stored on a computer-readable recording medium for executing each of the steps included in the method according to claim 3.

14. A computer program stored on a computer-readable recording medium for executing each of the steps included in the method according to claim 4.

15. A computer program stored on a computer-readable recording medium for executing each of the steps included in the method according to claim 5.
